(19) United States
(12) Patent Application Publication
(10) Pub. No.: US 2006/0115645 A1
(43) Pub. Date: Jun. 1, 2006

(54) Punch pad

(75) Inventors: Brian E. Andersen, Kaysville, UT (US); Cade Andersen, Kaysville, UT (US)

Correspondence Address: Starkweather and Associates, Suite 200, 9035 South 1300 East, Sandy, UT, 84094, US

(73) Assignee: A Major Corporation

(21) Appl. No.: 11/000,120

(22) Filed: Nov. 29, 2004

(51) Int. Cl. B32B 27/36; B32B 27/32; B32B 9/04

(52) U.S. Cl. 428/332; 428/412; 428/521; 428/411.1

(57) ABSTRACT

A punch pad with a multi-layer design that combines both an impact resistant layer and a rigid layer. The impact resistant layer has a mixture of polycarbonate and acrylonitrile butadiene styrene. Particularly, the impact resistant layer has between 10-90% polycarbonate, 10-90% acrylonitrile butadiene styrene, and 1-4% colorant. The rigid layer may be aluminum; however, any type of metal that bonds to the impact resistant layer is acceptable. An adhesive layer bonds the impact resistant layer and the rigid layer together. The rigid layer may be between about 0.040-0.25 inches thick and the impact resistant layer may be approximately 0.10 inches thick. The rigid layer may be anodized and may include a scratch preventative bottom side to prevent scratching underlying surfaces. The impact resistant layer may be injection molded to surround side portions of the rigid layer, or the entire rigid layer. A noise reducing layer may be attached to the punch pad to reduce the amount of noise created from the impact between the impact tool and the punch pad.

### BACKGROUND OF THE INVENTION

1. Field of the Invention

The present invention relates to a punch pad. Specifically, the present invention relates to a punch pad with a multi-layer design that combines both an impact resistant layer and a rigid layer.

2. Description of the Related Art

From small beginnings in the early 1990s, the scrapbooking industry has exploded into a multi-billion-dollar industry. Particularly, within the past couple of years, the collection and organizing of certain materials, such as pictures and other materials, into scrapbook format has become very popular. Methods of constructing scrapbook pages have evolved from simply cutting and pasting to ever-more-elaborate decorations, with various borders, attachments, covers, layouts, etc. Many people collect various family materials and combine them with printed graphics, designs, stamps and other formats to create artistic and attractive scrapbooks that can be shared with other family members and friends.

Some popular methods of constructing and embellishing scrapbook pages are using eyelets made of metal or other malleable material to attach different sections of the page together, stamping, and stamp cutting. Each method generally requires some type of impact tool with dies of varying sizes, shapes, and designs. A user creates particular designs by causing a die to impact the material, such as a paper product, leather, plastic, etc., which cuts the particular design into the material.

Scrapbookers have been inconvenienced, however, with the use of the impact tools and methods of creating the particular designs. If the underlying surface is too soft, the impact tool will not cut the material, and therefore cannot create an acceptable piece. Additionally, the underlying surface may be damaged. If the underlying surface is too hard, the material may not cut, and the die may be damaged.

Many scrapbookers have used wood, metal, or plastic as punch pads to overcome the previously disclosed problems, but have subsequently run into additional problems. For instance, wood punch pads damage too easily and clog dies, especially highly intricate die designs. Metal punch pads are too heavy and damage and dull the dies connected to the impact tools. Additionally, metal punch pads are noisy. Finally, plastic alone is generally too rigid and may crack when hit with the impact tool.

It can be seen that there is a need for a punch pad that effectively overcomes the previously disclosed problems associated with using punch pads to prevent damage from impact tools. Specifically, there is a need for a punch pad that is modular and that protects the underlying surface, that does not damage dies, and that helps eliminate noise associated with impact tools.

### SUMMARY OF THE INVENTION

The present invention has been developed in response to the present state of the art, and in particular, in response to the problems and needs in the art that have not yet been fully solved by currently available punch pads. Accordingly, the present invention has been developed to provide a punch pad that overcomes many or all of the above-discussed shortcomings in the art.

Specifically, the present invention provides a punch pad with a multi-layer design that combines both an impact resistant layer and a rigid layer. In one embodiment, the impact resistant layer comprises a mixture of polycarbonate and acrylonitrile butadiene styrene, however any type of similar material is acceptable. Particularly, the outer impact resistant layer may comprise 10-90% polycarbonate, 10-90% acrylonitrile butadiene styrene, and 1-4% colorant. In another embodiment, the rigid layer may be aluminum; however, any type of metal or rigid material that bonds to the impact resistant layer is acceptable. An adhesive layer bonds the impact resistant layer and the rigid layer together.

In another embodiment, the rigid layer is at least 0.04 inches thick. In another embodiment, the rigid layer is between about 0.04 to 0.25 inches thick, or any other suitable dimension.

In further embodiment, the impact resistant layer is approximately 0.10 inches thick.

In yet an additional embodiment, the impact resistant layer surrounds side portions of the rigid layer.

In still another embodiment, the punch pad includes a noise reducing layer for reducing the noise created from the impact between the impact tool and the punch pad.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention, as well as other features and advantages not listed, will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a punch pad according to one embodiment of the present invention;

FIG. 2 illustrates a cross sectional side view of a punch pad according to one embodiment of the present invention;

FIG. 3 illustrates another cross sectional side view of a punch pad according to one embodiment of the present invention; and

FIG. 4 illustrates a cross sectional side view of a punch pad with a noise reducing layer according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

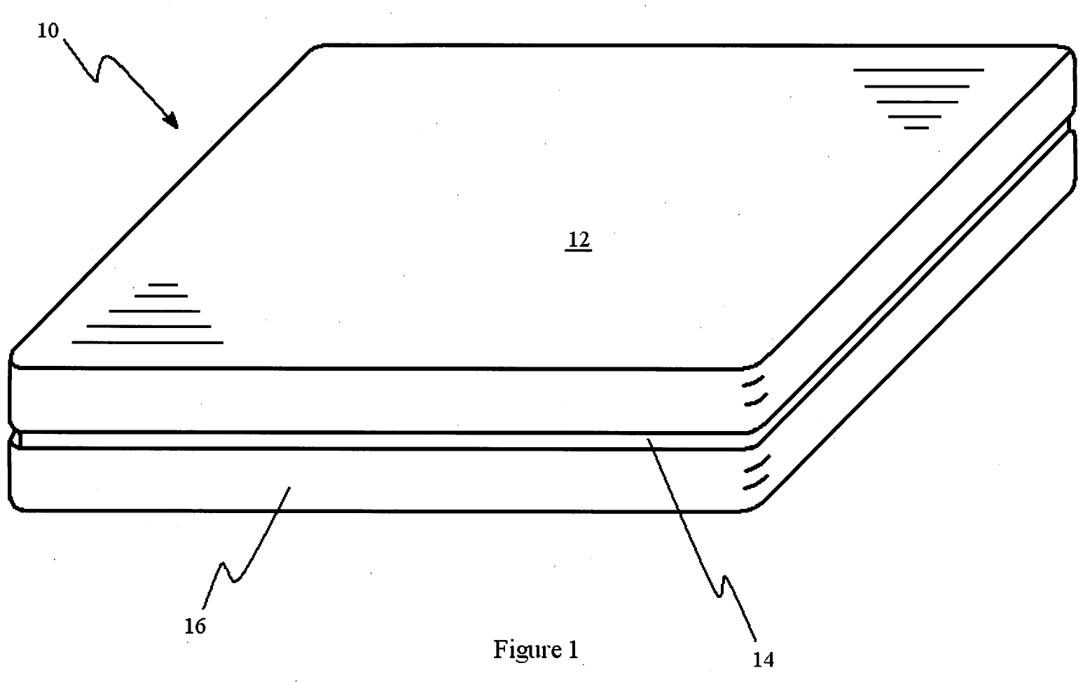

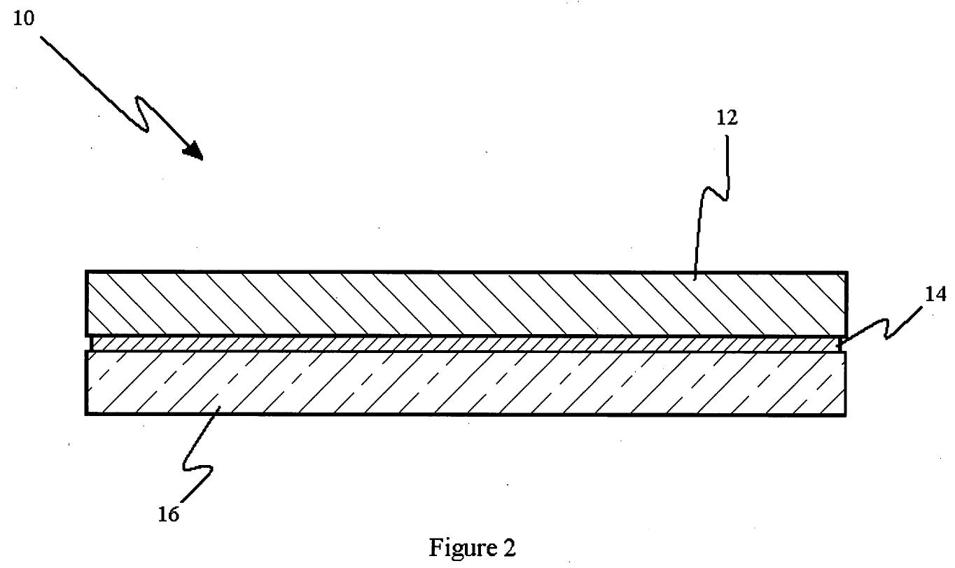

FIGS. 1-2 illustrate a perspective top view, and side cross sectional view of a representative punch pad 10 according to various embodiments of the present invention. The punch pad 10 comprises a multi-layer design that combines both an impact resistant layer 12 and a rigid layer 16, which are fastened together with an adhesive or fastener 14. In one embodiment, the impact resistant layer 12 comprises a mixture of polycarbonate and acrylonitrile butadiene styrene. Particularly, the impact resistant layer 12 may comprise 10-90% polycarbonate, 10-90% acrylonitrile butadiene styrene, and 1-4% colorant. Different mixtures of the polycarbonate and acrylonitrile butadiene styrene can increase or decrease the resiliency and make the impact resistant layer 12 harder or softer. One skilled in the art will recognize that there are numerous types of materials and compositions of materials, compounds, and chemicals, that may be used to form the impact resistant layer 12.

Preferably, the impact resistant layer 12 is approximately 0.10 inches thick. However, the thickness of the impact resistant layer 12 may be thicker or thinner depending on the type of material used and the force intended to be used from an impact tool (not shown) such as those taught in U.S. Pat. No. 2,675,079, to Hughes, U.S. Pat. No. 5,433,007 to Clark, U.S. Pat. No. 5,307,741 to Clark, and U.S. Pat. No. 3,385,380 to Waller. Naturally, a more powerful impact tool, or a stronger material to be cut, may require a thicker impact resistant layer 12.

The rigid layer 16 is configured to provide a strong base to prevent unnecessary or detrimental deflection of the impact resistant layer 12 upon impact from the impact tool. Preferably, the rigid layer 16 is between about 0.04 inches and 0.25 inches. Advantageously, the rigid layer 16 allows the user to use the punch pad 10 over almost any working surface, including soft surfaces, such as a card table, chair, carpeted floor, lap, etc. It has even been found that the user can use the punch pad over a pillow.

In one embodiment, the rigid layer 16 is made of aluminum for its light weight characteristics. Of course, other metals, composites, woods, and plastics may be appropriate depending on their thickness, strength, and weight. In one embodiment, the aluminum may include a scratch preventative layer (not shown) on a bottom side to prevent the aluminum from scratching a table or other underlying surface.

The adhesive layer 14 may be any type of adhesive well known in the art for adhering the impact resistant layer 12 to the rigid layer 16. It is also envisioned that screws, bolts, clasps, clamps, fasteners, nails, binders, binding material, and melting techniques may also be used to fasten the impact resistant layer 12 to the rigid layer 16. Preferably, adhesives are used to prevent interfering with, and damaging the dies of the impact tool.

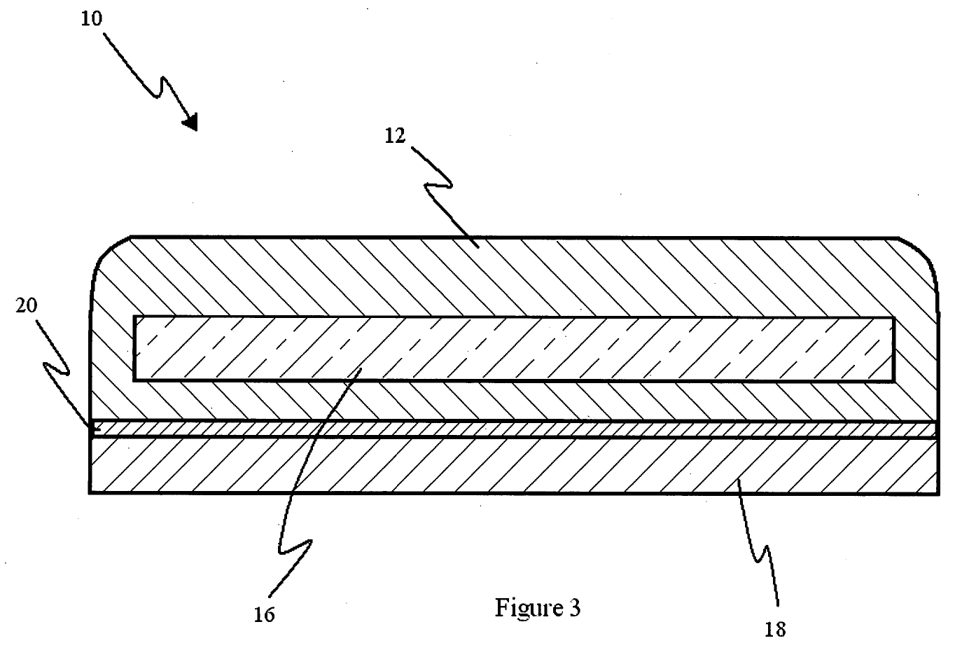

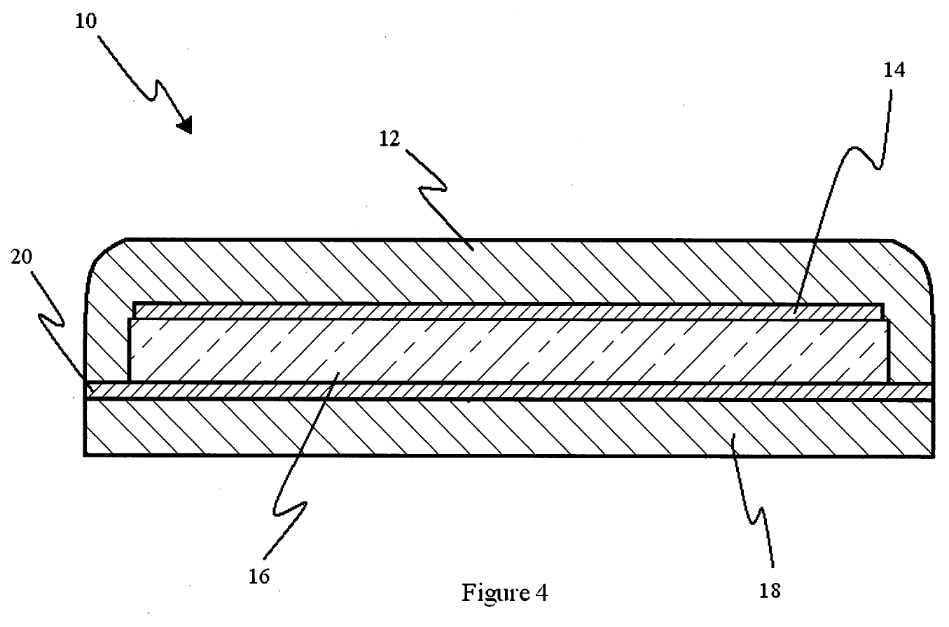

FIGS. 3 and 4 illustrate side cross sectional side views of a punch pad with a noise reducing layer according to one embodiment of the present invention. The punch pad 10 may be injection molded to form the impact resistant layer 12 completely around the rigid layer 16 (See FIG. 3). In another embodiment, the impact resistant layer 12 surrounds only the sides and top of the rigid layer 16 (See FIG. 4). The impact resistant layer 12 is injection molded directly to the rigid layer 16. In another embodiment, the impact resistant layer 12 may be preformed and adhered to the rigid layer 16 with the adhesive layer 14 on one or more sides.

It is also envisioned that the punch pad may comprise a noise reducing layer 18. For instance, a neoprene based material may be attached to the bottom of the rigid layer 16 via an adhesive 20, or other fastening device, so that when the impact tool hits the punch pad 10, the neoprene layer subdues the noise generated. In another embodiment, if the impact resistant layer 12 fully envelopes the rigid layer 16, the noise reducing layer 18 may be attached to the impact resistant layer 12 between the impact resistant layer 12 and the working surface. The neoprene layer may be fastened in a variety of ways, including, but not limited to adhesives, screws (including plastic), bolts, clasps, clamps, fasteners, nails, and melting techniques.

The impact resistant layer 12 is configured to receive a force exerted against it from the impact tool. In operation, a user places a material, such as a piece of paper, leather, plastic, etc., over the punch pad 10 and, using the impact tool, rapidly forces a die upon the material to form, or cut, a particular design into the material. If used correctly, the die should cause a force upon the punch pad, through the material, and in many cases, sufficient to enter, or deform the punch pad 10. The impact resistant layer 12 is configured to absorb the force exerted from the impact tool to prevent the impact resistant layer 12 from cracking or breaking. The rigid layer 16 prevents the punch pad 10 from deforming and allows the user to use the punch pad 10 anywhere. The noise reducing layer 18 helps eliminate the noise produced when the impact tool strikes the punch pad 10.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the specification discusses the use of a mixture of polycarbonate and ABS, it is envisioned that any kind of material may be used as the impact resistant layer. Preferably, the impact resistant layer comprises a resilient material capable of deformation, and a material capable of withstanding strong forces, which is tough, and strong. One skilled in the art will recognize that there are other types of materials that satisfy these requirements that can be implemented into various embodiments of the present invention.

Although the specification discusses the use of rigid layers and impact resistant layers of specific thickness, it is envisioned that the layers can be any thickness, as long as the general purpose of each layer is accomplished. Specifically, the present invention is generally described for the purpose of providing a light weight mobile punch pad. Accordingly, the punch pad dimensions have been described to allow for easy mobility. It is understood, and envisioned, that the punch pad may be increased in size, decreased in size, or changed in shape when mobility of the punch pad is not important.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A punch pad, comprising:
an impact resistant layer configured to receive a force from an impact device;
a rigid layer attached to the impact resistant layer, and configured to prevent the impact resistant layer from substantial deflection when a force is applied against the impact resistant layer; and
a binder configured to bind the rigid layer to the impact resistant layer.

2. The punch pad according to 1, wherein the impact resistant layer comprises polycarbonate and acrylonitrile butadiene styrene.

3. The punch pad according to claim 2 wherein the impact resistant layer comprises about 10-90% polycarbonate and about 10-90% acrylonitrile butadiene styrene.

4. The punch pad according to claim 3, further comprising about 1-4% colorant.

5. The punch pad according to claim 1, wherein the impact resistant layer comprises polycarbonate.

6. The punch pad according to claim 1, wherein the impact resistant layer comprises acrylonitrile butadiene styrene.

7. The punch pad according to claim 1, wherein the impact resistant layer envelopes the rigid layer.

8. The punch pad according to claim 1, wherein the impact resistant layer is approximately 0.10 inches thick.

9. The punch pad according to claim 9, wherein the rigid layer is between about 0.040 and 0.25 inches thick.

10. A punch pad, comprising:
an impact resistant layer configured to receive a force from an impact device;
a rigid layer attached to the impact resistant layer, and configured to prevent the impact resistant layer from substantial detrimental deflection when a force is applied against the impact resistant layer;
a noise reducer coupled to the rigid layer opposite to the impact resistant layer; and
a fastening means for fastening the rigid layer adjacent to the impact resistant layer.

11. The punch pad according to claim 11, wherein the noise reducer is a neoprene based material.

12. The punch pad according to claim 11, wherein the noise reducer is attached to the rigid layer.

13. The punch pad according to claim 11, wherein the impact resistant layer comprises a polycarbonate material.

14. The punch pad according to claim 11, wherein the impact resistant layer comprises an acrylonitrile butadiene styrene material.

15. The punch pad according to claim 11, wherein the impact resistant layer comprises polycarbonate and acrylonitrile butadiene styrene materials.

16. The punch pad according to claim 16 wherein the impact resistant layer comprises about 10-90% polycarbonate material and about 10-90% acrylonitrile butadiene styrene material.

17. The punch pad according to claim 16, further comprising about 1-4% colorant.

18. The punch pad according to claim 11, wherein the impact resistant layer envelopes the rigid layer.

19. The punch pad according to claim 11, wherein the impact resistant layer is approximately 0.10 inches thick and the rigid layer is between about 0.04 and 0.25 inches thick.

20. A punch pad, comprising:
an impact resistant layer configured to receive a force from an impact device;
a rigid layer attached to the impact resistant layer, and configured to prevent the impact resistant layer from substantial detrimental deflection when a force is applied against the impact resistant layer;
a noise reducer coupled to the impact resistant layer, and configured to be positioned between the rigid layer and a working surface; and
a fastening means for fastening the noise reducer to the impact resistant layer.
